(19) United States
(12) Patent Application Publication
(10) Pub. No.: US 2004/0177557 A1
(43) Pub. Date: Sep. 16, 2004

(54) Retractable cover apparatus for outdoor storage bins

(76) Inventor: Alois Reissler, Clarksburg (CA)

Correspondence Address: HOFBAUER ASSOCIATES, SUITE 205 NORTH, 1455 LAKESHORE ROAD, BURLINGTON, ON, L7S 2J1, CA

(21) Appl. No.: 10/383,721

(22) Filed: Mar. 10, 2003

(51) Int. Cl. E05D 15/58; E06B 11/00; E05F 11/02; B61L 29/08

(52) U.S. Cl. 49/260; 49/332

(57) ABSTRACT

A retractable cover apparatus for use with an open-top bin is disclosed and comprises a cover and a support. The cover includes a cover portion and one or more carriage portions. Each carriage portion includes a pair of spaced-apart rollers rotatably mounted to said cover portion. The support defines a bifurcated track which permits constrained movement of said rollers in a manner which provides for movement of said cover between a sheltering position and an upwardly tilted open position; and between the sheltering position and a sealed position, relatively lower than the sheltering position. At the sheltering position, the cover overlies said open top when said bin is operatively disposed therebeneath; at the open position, the cover permits loading into said bin when said bin is operatively positioned; and at the sealed position, the cover is adapted to substantially seal said open top against the infiltration of atmospheric precipitation.

### FIELD OF THE INVENTION

The present invention relates to the field of outdoor storage bins, and more specifically, to a retractable cover apparatus therefor.

### BACKGROUND OF THE INVENTION

It is well known for manufacturing undertakings and the like to utilize outdoor storage bins to temporarily store scrap metal and other waste materials until such time as they can be recycled or otherwise properly disposed of.

To enable said bins to be readily loaded by, for example, front end loaders, and to be readily unloaded by associated cartage vehicles, and for various other reasons, many existing bins of this sort are provided with an open top. It is known to provide relatively massive hinged lids for such bins, and it is also known to provide lids for such bins which can be lifted off and placed, for example, on the ground. However, because of the inconvenience associated with opening and closing the hinged lids, and associated with the removal and replacement of the removable lids, such bins, even if provided with lids, are often left exposed to the elements, including, among other things, periodic precipitation, namely, rain, hail, sleet and snow, depending upon climate. It will be evident that this renders it possible for large amounts of water to accumulate in such bins, which could complicate subsequent transport, and could also add to disposal costs, since disposal costs typically vary with tonnage.

One method known in the prior art to avoid the foregoing involves the provision of drainage holes. However, in that this method does not divert precipitation from entering the bins, it suffers, since the contents still become periodically exposed to precipitation, and can therefore absorb moisture, thereby increasing disposal costs.

Further, since the contents of such bins have often previously come into contact with environmentally hazardous materials, such as, for example, grease, oil and/or paint, this method renders it possible for land and associated ground water in the vicinity to become contaminated, if such hazardous materials become comingled with the effluent from the bin. Such contamination can result in diminished resale values for such land and/or the imposition of serious positive environmental clean-up obligations on the land owner.

### SUMMARY OF THE INVENTION

It is an object of the present invention to provide a retractable cover apparatus for use with a bin having an open top that is relatively reliable in operation, relatively convenient in use and relatively economical to manufacture and use.

This object, amongst others, is met by the present invention, a retractable cover apparatus for use with a bin having an open top.

As one aspect of the invention, the apparatus comprises a cover assembly and a guide means. The cover assembly includes a cover portion and one or more carriage portions, each carriage portion including a pair of spaced-apart shuttle members operatively mounted to said cover portion in spatially-fixed relation. The guide means is for permitting constrained movement of said shuttle members in a manner which provides for movement of said cover assembly between a substantially horizontal sheltering position, whereat said cover assembly substantially overlies said open top to impede infiltration of atmospheric precipitation into said bin when said bin is disposed at an operative position therebeneath, and an upwardly tilted open position, whereat said cover assembly is positioned to permit loading into said bin when said bin is operatively positioned.

As another aspect of the invention, the guide means is preferably further adapted to permit constrained movement of said shuttle members in a manner which provides for movement of said cover assembly between the sheltering position and a sealed position, relatively lower than the sheltering position, whereat said cover assembly is adapted to substantially seal said open top against the infiltration of atmospheric precipitation.

As another aspect of the invention, actuation means is preferably provided for selectively moving the cover assembly from its sealed position to its sheltering position, and for selectively moving the cover assembly from its open position to its sheltering position, and the cover assembly is preferably biased for movement by the force of gravity from its sheltering position to its sealed position.

As yet another aspect of the invention, switch means is preferably provided for selectively directing movement of the cover assembly from the sheltering position to the open position thereof, said cover assembly being biased by gravity for movement from said sheltering position to said open position when so selectively directed.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinafter.

### BRIEF DESCRIPTION OF THE DRAWINGS

In the accompanying drawings, wherein like reference numerals are used to depict similar elements of structure, wherein certain concealed portions of the structure are shown in phantom outline for clarity, and which are not intended as a definition of the limits of the invention:

FIG. 1 is a perspective view of a retractable cover apparatus according to a preferred embodiment of the present invention, in use with a bin, a cover assembly of the preferred embodiment being shown at a sealed position thereof;

FIG. 2 is an enlarged view of the encircled area 2 of FIG. 1;

FIG. 3 is a rear elevational view of the structure of FIG. 1;

FIG. 4 is an enlarged view of the encircled area 4 in FIG. 3;

FIG. 5 is a side elevational view of the structure of FIG. 1, with a sheath portion thereof removed for clarity;

FIG. 6 is an enlarged view of the encircled area 6 in FIG. 5;

FIG. 7 is a view of the structure of FIG. 5, with the cover assembly shown at a sheltering position thereof and a switch member thereof shown at a first position thereof;

FIG. 8 is an enlarged view of the encircled area 8 of FIG. 7;

FIG. 9 is a view similar to FIG. 7, with the switch member shown at a second-position thereof;

FIG. 10 is an enlarged view of the encircled area 10 of FIG. 9;

FIG. 11 is a view similar to FIG. 9, with the cover assembly relatively downwardly displaced;

FIG. 12 is an enlarged view of the encircled area 12 of FIG. 11;

FIG. 13 is a view similar to FIG. 11, with the cover assembly downwardly displaced and pivoted counter-clockwise;

FIG. 14 is an enlarged view of the encircled area 14 of FIG. 13;

FIG. 15 is a view similar to FIG. 13, with the cover assembly illustrated at an upwardly tilted open position thereof;

FIG. 16A is a view similar to FIG. 2, showing a switch member disposed at its first position;

FIG. 16B is a view similar to FIG. 16A, with a pin portion retracted;

FIG. 16C is a view similar to FIG. 16B, with the switch member disposed at its second position;

FIG. 16D is a view similar to FIG. 16C, with the pin portion engaged;

FIG. 17 is an exploded perspective view of the structure of FIG. 1; and

FIG. 18 is a top plan view of the structure of FIG. 1.

### DETAILED DESCRIPTION OF A PREFERRED EMBODIMENT

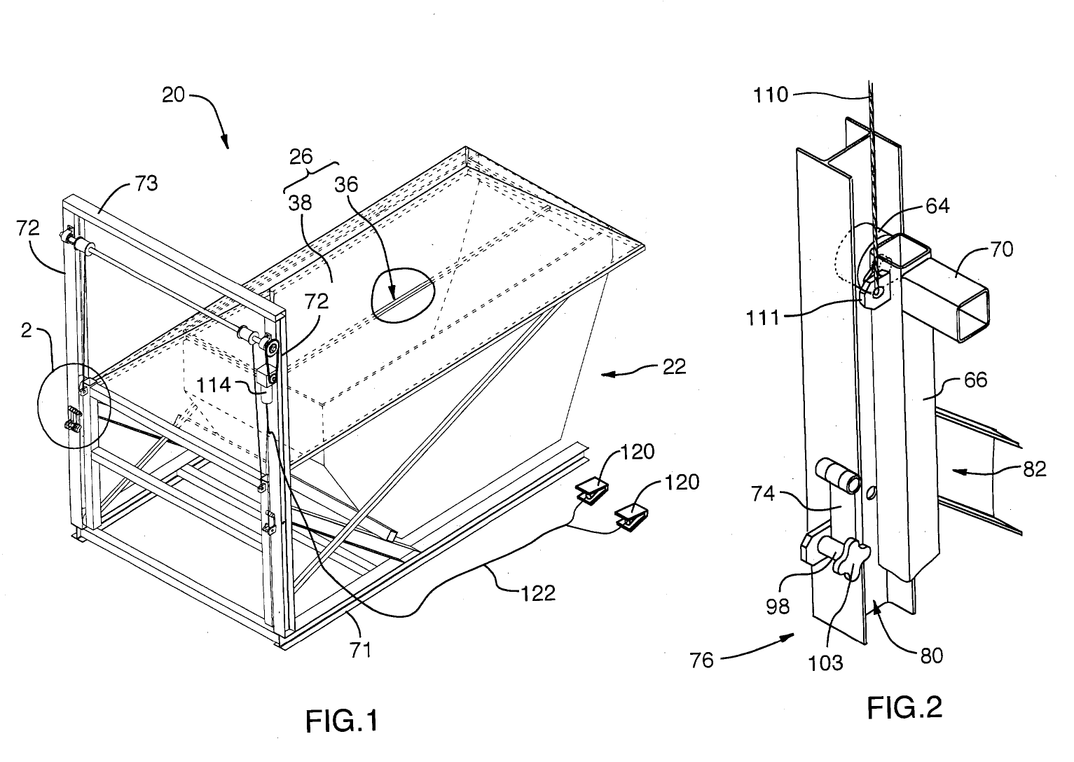

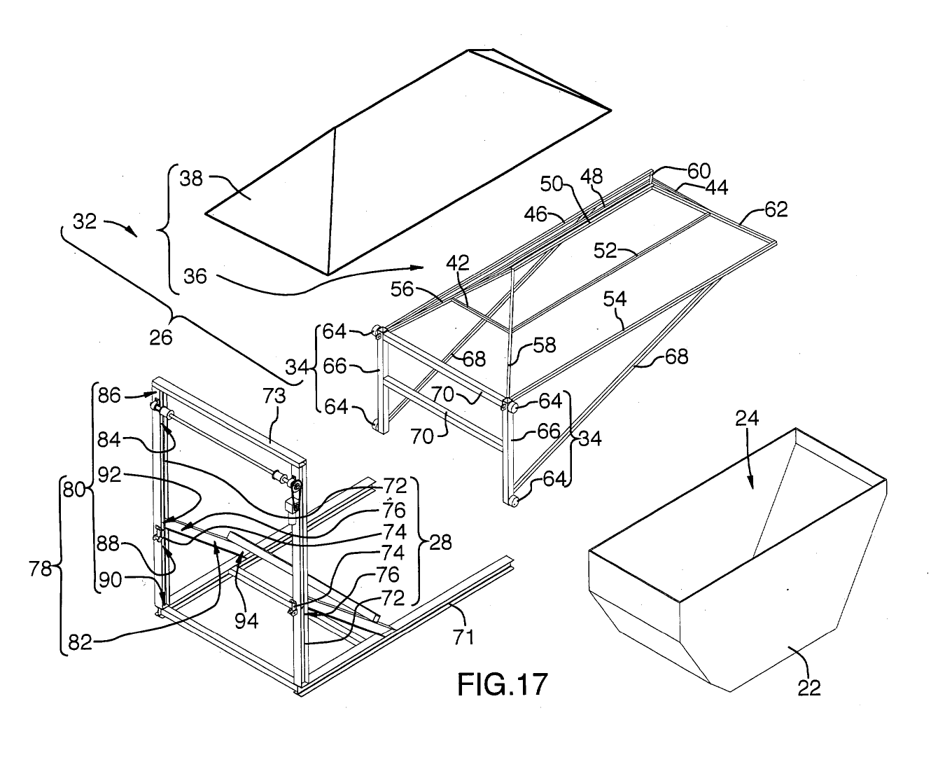

Referring now to FIG. 1 of the drawings, a rectractable cover apparatus according to a preferred embodiment of the present invention and designated with general reference numeral 20 is shown in use with a bin 22. As best illustrated in FIG. 17, wherein the structure of FIG. 1 is shown in exploded perspective, the bin 22 has an open top 24. For greater certainty, the bin 22 does not form part of the invention.

The retractable cover apparatus 20 of the preferred embodiment includes a cover assembly 26, a guide means 28, an actuation means 30 and a switch means 31, all as generally indicated in FIG. 5.

As illustrated in FIG. 17, the cover assembly 26 includes a cover portion 32 and one or more carriage portions 34.

The cover portion 32 comprises a support skeleton 36 and a mating flexible sheath 38. The support skeleton 36 is composed of laterally extending cross-pieces 42,44 rigidly connected to one another by longitudinally extending frame members 46,48,50,52,54 and by diagonal braces 56,58,60,62.

In the preferred embodiment illustrated, a pair of carriage portions 34 are provided, each carriage portion 34 including a pair of spaced-apart shuttle members 64, namely, rollers, operatively rotatably mounted to said cover portion 32 in spatially-fixed relation.

As illustrated, each shuttle member 64 is rotatably mounted to a carriage body 66, which, in turn, is secured to the support skeleton 36. To rigidly tie the assembly together, a pair of struts 68 are provided, which extend between the carriage bodies 66 and the support skeleton 36, as is a pair of lateral carriage braces 70, which extend between the carriage bodies 66.

The support skeleton 36, carriage bodies 66, struts 68 and braces 70 are each preferably constructed from square tubular steel, and conventionally fastened together by welding; the shuttle members 64 preferably consist of rubber wheels mounted on conventional bearings (neither shown in detail); and the sheath 38 is constructed from waterproof fabric material, preferably vinyl, suitably stitched together and attached to the support skeleton 36, and provide with a substantially smooth surface so as to resist adherence by snow and the like.

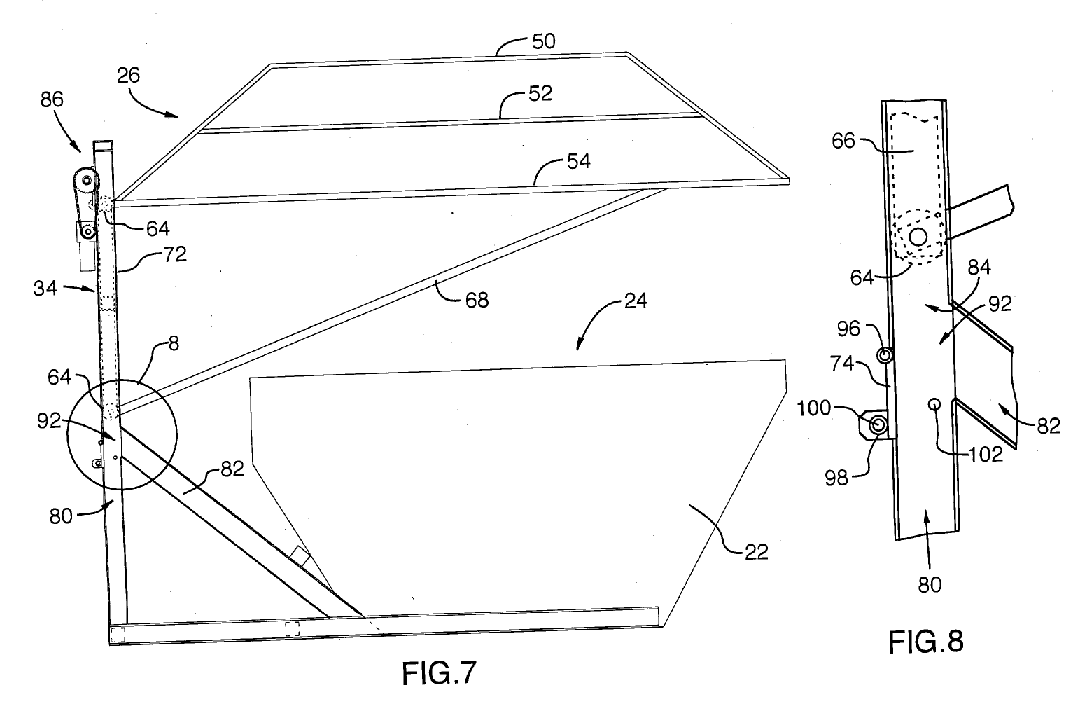

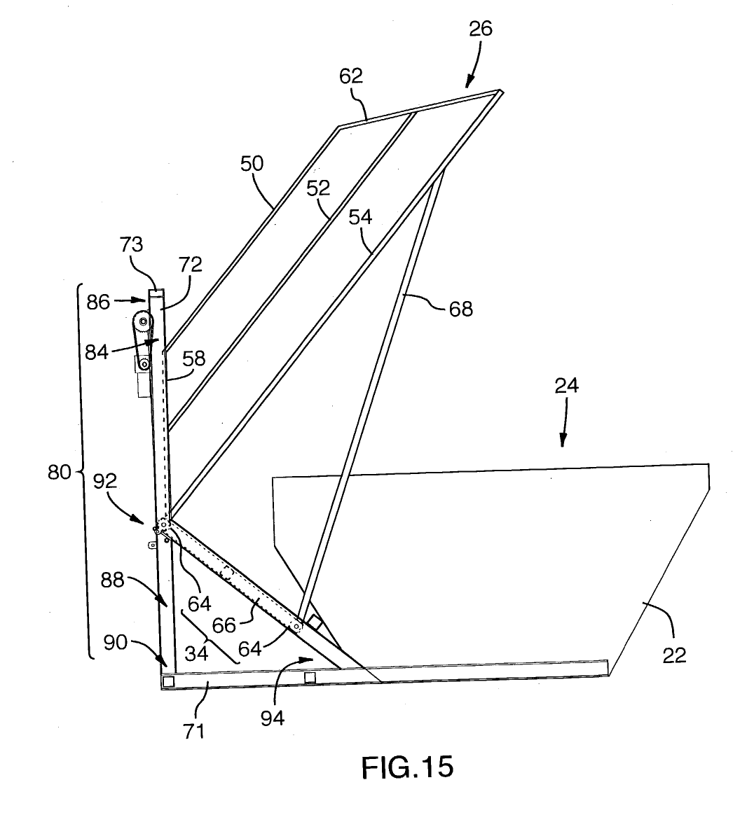

The guide means 28 permits constrained movement of said shuttle members 64 in a manner which provides for movement of said cover assembly 26 between a substantially horizontal sheltering position, whereat said cover assembly 26 substantially overlies said open top 24 of the bin 22 to impede infiltration of atmospheric precipitation into said bin when said bin is disposed at an operative position therebeneath, as illustrated in FIG. 7, and an upwardly tilted open position, whereat said cover assembly 26 is positioned to permit loading into said bin 22 when said bin 22 is operatively positioned, as illustrated in FIG. 15.

The guide means 28 further permits constrained movement of said shuttle members 64 in a manner which provides for movement of said cover assembly 26 between the sheltering position shown in FIG. 7 and a sealed position, relatively lower than the sheltering position, as shown in FIG. 5, whereat said cover assembly 26 is adapted to substantially seal said open top 24. For the purpose of this disclosure and the accompanying claims, it should be understood that the seal provided by the cover assembly 26 merely serves to impede the infiltration of atmospheric precipitation into the bin 22, and does not, for example, hermetically seal the bin 22.

As illustrated in FIG. 17, in the preferred embodiment illustrated, the guide means 28 comprises a pair of support members 72, one for each carriage portion 34, said support members 72 being rigidly connected to a base 71 and connected to one another by a crossbeam 73.

Each support member 72 is constructed of steel I-beams and is conventionally cut and welded to define a bifurcated passage 78 in which the shuttle members 64 of said each carriage portion 34 are mounted for guided movement, said bifurcated passage 78 including a substantially vertical elongate primary passage 80 and an elongate secondary passage 82.

The primary passage 80 has an upper end portion 84 including an upper end 86, a lower end portion 88 including a lower end 90 and an intermediate junction portion 92.

The secondary passage 82 extends downwardly from said junction portion 92, in skewed relation to the lower end portion 88 of the primary passage 80, to a terminus 94.

The bifurcated passage 78 provides for guided movement of the shuttle members 64 mounted therein in a manner which permits movement of the carriage portion 34 of which said shuttle members 64 form part between a raised position adjacent the upper end 86 of the primary passage 80, as shown in FIG. 7, a lowered position, adjacent the lower end 90 of the primary passage 80, as shown in FIG. 5, and an offset position adjacent the terminus 94 of the secondary passage 82, as shown in FIG. 15. Of course, as the carriage bodies 66 are mounted to one another by braces 70, they move in concert between their respective positions.

As evident from FIG. 7, the raised position of the carriage portions 34 corresponds to the sheltering position of the cover assembly 26, at which position, each pair of shuttle members 64 is disposed, with respect to the support member 72 for the carriage.portion 34 of which said pair form part, adjacent the upper end 86 and the junction portion 92 of the primary passage 80, respectively.

As evident from FIG. 5, the lowered position of the carriage portions 34 corresponds to the sealed position of the cover assembly 26, at which position, each pair of shuttle members 64 is disposed, with respect to the support member 72 for the carriage portion 34 of which said pair form part, adjacent the lower end 90 and the junction portion 92 of the primary passage 80, respectively.

As evident from FIG. 15, the offset position of the carriage portions 34 corresponds to the open position of the cover assembly 26, at which position, each pair of shuttle members 64 is disposed, with respect to the support member 72 for the carriage portion 34 of which said pair form part, adjacent the junction portion 92 of the primary passage 80 and the terminus 94 of the secondary passage 82, respectively.

The cover assembly 26 is biased for movement by the force of gravity from its sheltering position to its sealed position, and the actuation means 30 is provided for effecting movement of the cover assembly 26 in the opposite direction, namely, for selectively moving the cover assembly 26 from its sealed position to its sheltering position, and for selectively moving the cover assembly 26 from its open position to its sheltering position.

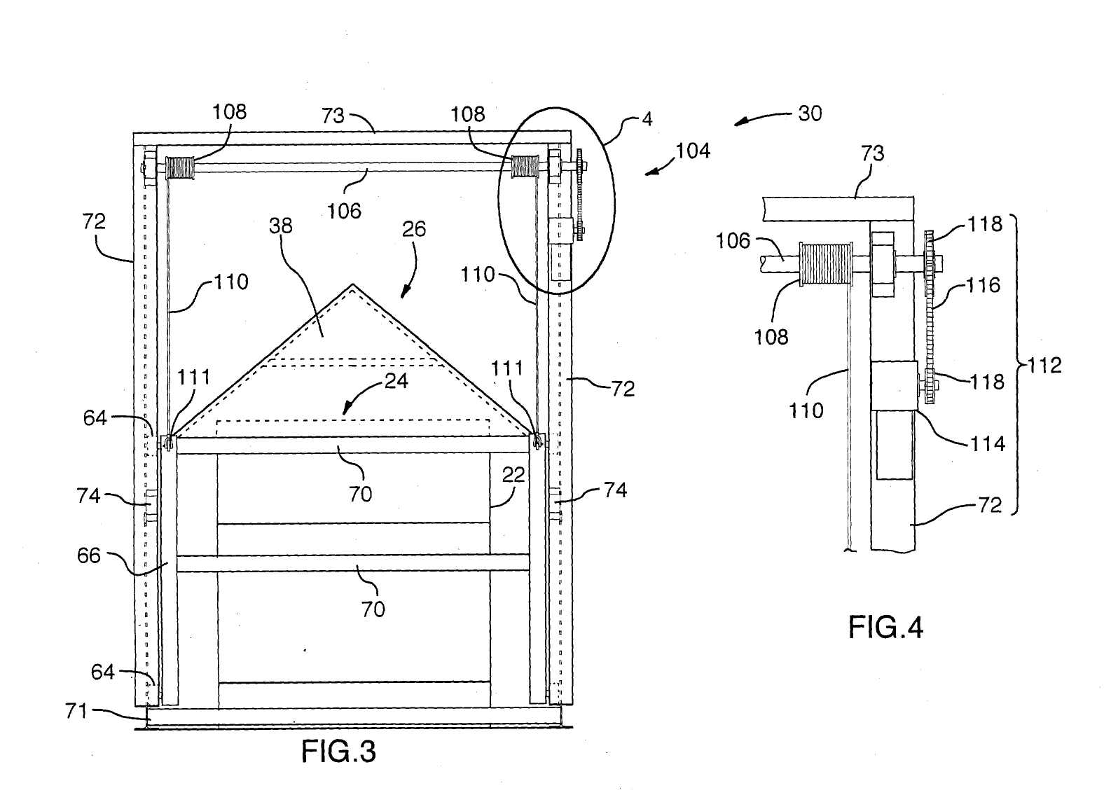

In the preferred embodiment illustrated, the actuation means 30 comprises a cable winch 104 which, as best viewed in FIG. 3 and 4, comprises a laterally-extending shaft 106 rotatably mounted to the support members 72; a pair of spools 108 mounted, in laterally-spaced relation, on said shaft 106 for rotation therewith; a pair of cables 110, each cable 110 being affixed at its ends, respectively, to a respective one of said pair of spools 108 and to the cover assembly 26, by lugs 111; and motive means 112 for selectively driving rotation of said shaft 106.

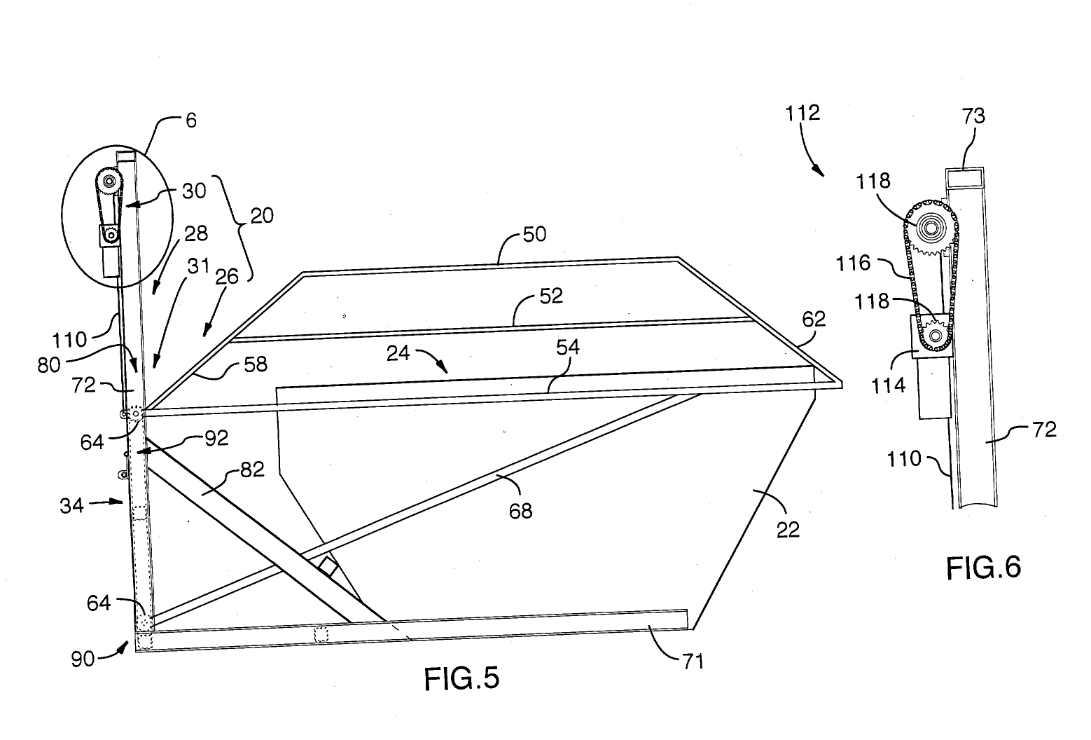

As best illustrated in FIG. 4 and FIG. 6, the preferred motive means 112 comprises an electric motor 114 drivingly coupled to said shaft 106 by a chain 116 and sprocket 118 assembly.

The electric motor 114 has extending therefrom, as best illustrated in FIG. 1, an extension cord 122 terminating in a pair of alligator-type clips 120 shaped and dimensioned to receive the terminals of the power supply of a fork lift or the like (not shown), thereby to permit the electric motor 114 to receive driving electrical current therefrom. Alternatively, mating plugs (not shown) may be secured to the extension cord 120 and to the cartage vehicle, to facilitate such connection.

The switch means 31 is provided for selectively directing movement of the cover assembly 26 from the sheltering position to the open position thereof, said cover assembly 26 being biased by gravity. for movement from said sheltering position to said open position when so selectively directed by the switch means 31.

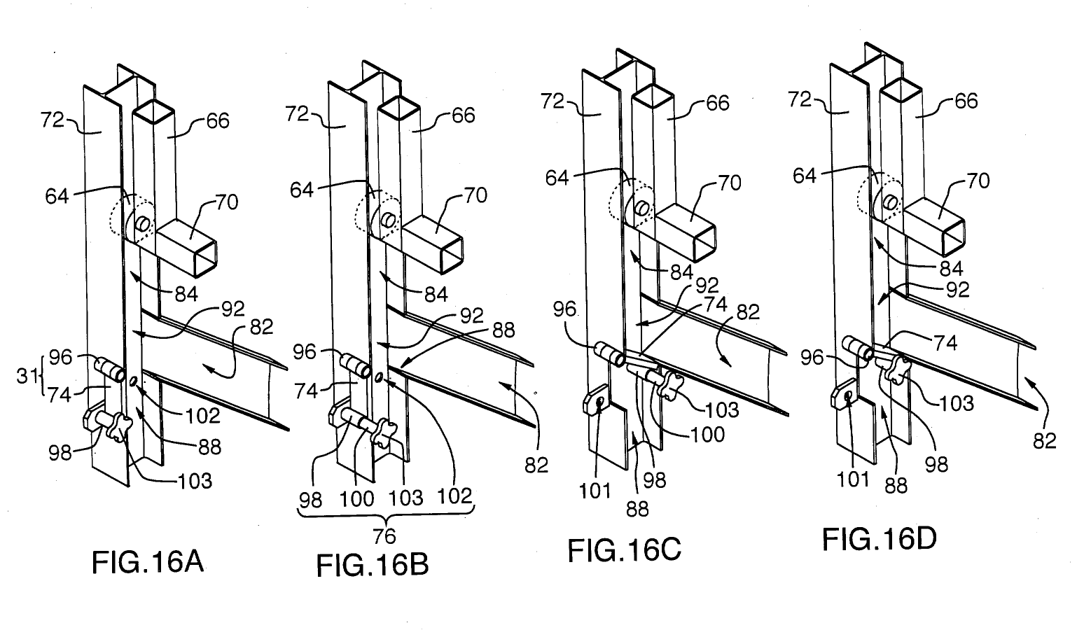

The preferred switch means 31 comprises, for each carriage portion 34, a switch member 74, namely, a steel flap, hingedly mounted, by a pivot pin 96, to said support member 72 for said each carriage portion 34 for movement through manual manipulation between a first position shown in FIG. 16A, and a second position, shown in FIG. 16D.

At its first position (see FIG. 16A), the switch member 74 permits ingress of said shuttle members 64 into the lower end portion 88 of the primary passage 80.

At its second position (see FIG. 16D), the switch member 74 directs shuttle members 64 exiting the upper end portion 84 of the primary passage 80 in to the secondary passage 82, and directs shuttle members 64 exiting the secondary passage 82 into the upper end portion 84 of the primary passage 80.

A manually-operable pin and socket locking assembly 76 is preferably provided for each switch member 74 and is adapted to permit the switch member 74 to be selectively locked at one of its first position and its second position.

In the preferred embodiment illustrated, this is effected by securing a cylindrical sleeve 98 to the switch member 74. A pin 100 is mounted in the sleeve 98 for reciprocating sliding movement; sockets 101,102 are provided in the support member 72, as illustrated in FIGS. 16A-16D; and a handle 103 is provided, and rigidly secured to the pin 100 to permit manual manipulation thereof.

The retractable cover apparatus 20 will usually be disposed at its sealed position over an operatively positioned bin, thereby to limit the infiltration of precipitation, as viewed in FIG. 1.

In operation, when it is desired to load the bin 22, the operator, typically of a fork lift (not shown), will manipulate his or her vehicle into position near the bin 22, park the vehicle and dismount therefrom. Thereafter, the operator will engage the alligator clips 120 to the terminals of the battery of the fork lift (not shown), to energize the motor 114. Thus energized, the operator will, through a conventional switch (not shown), actuate the motor 114 for movement, which drives the shaft 106, through the chain 116 and sprocket assembly 118, to coil the cables 110 onto spools 108 and urge the cover assembly 26 to its sheltering position shown in FIG. 7. At its sheltering position, the motor 114 will be disengaged, whereupon an internal magnetic brake (not shown) locks the motor 114, and thus the shaft 106 operatively connected thereto, against movement.

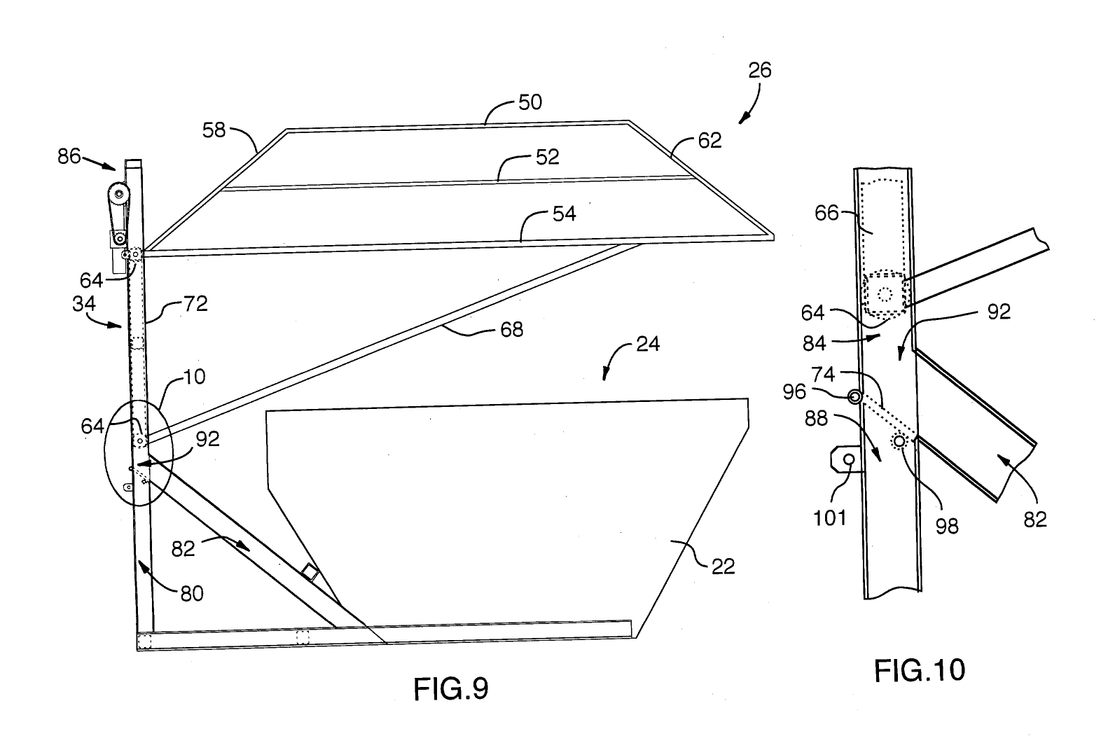

With the cover assembly 26 so immobilized, the operator will then lockingly reposition each switch member 74 at its respective second position, as shown in FIG. 9. This is effected by pulling on its handle 103 to partially withdraw pin 100 from its sleeve 98 and disengage pin 100 from socket 101, manipulating the switch member 74 to its second position, and depressing the handle 103, to reseat the pin 100 into its associate sleeve 98 and into socket 102. This process is illustrated in the sequence of FIGS. 16A, 16B, 16C, 16D.

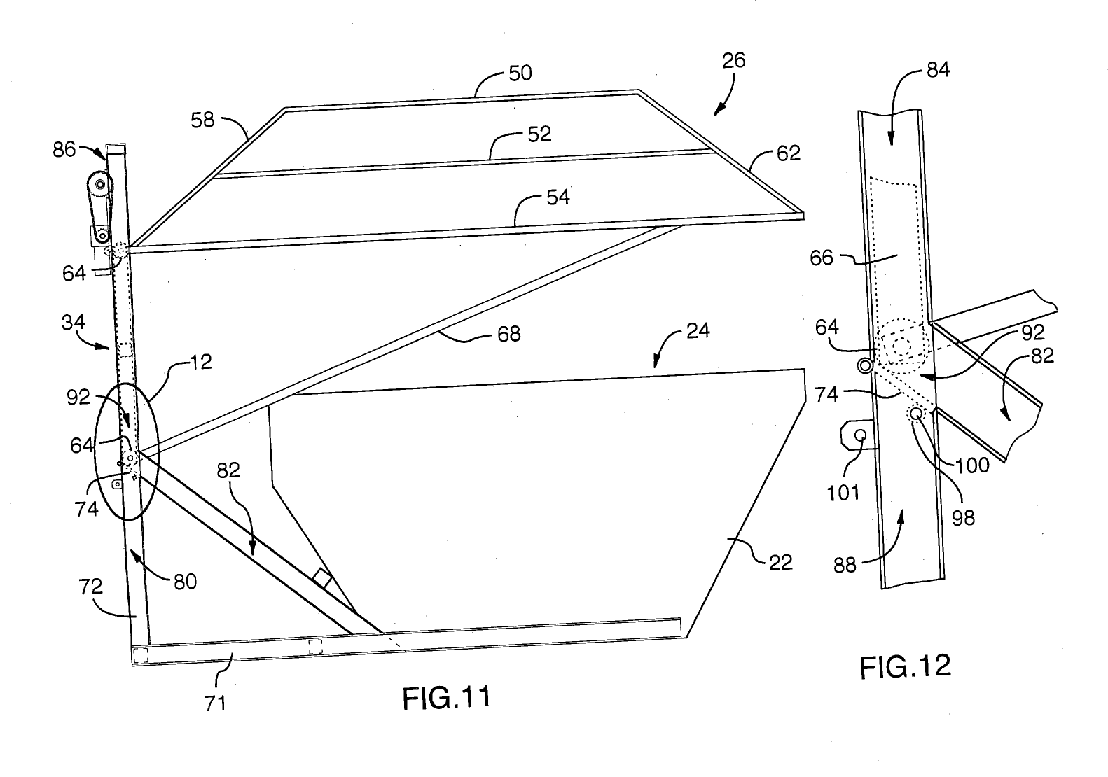

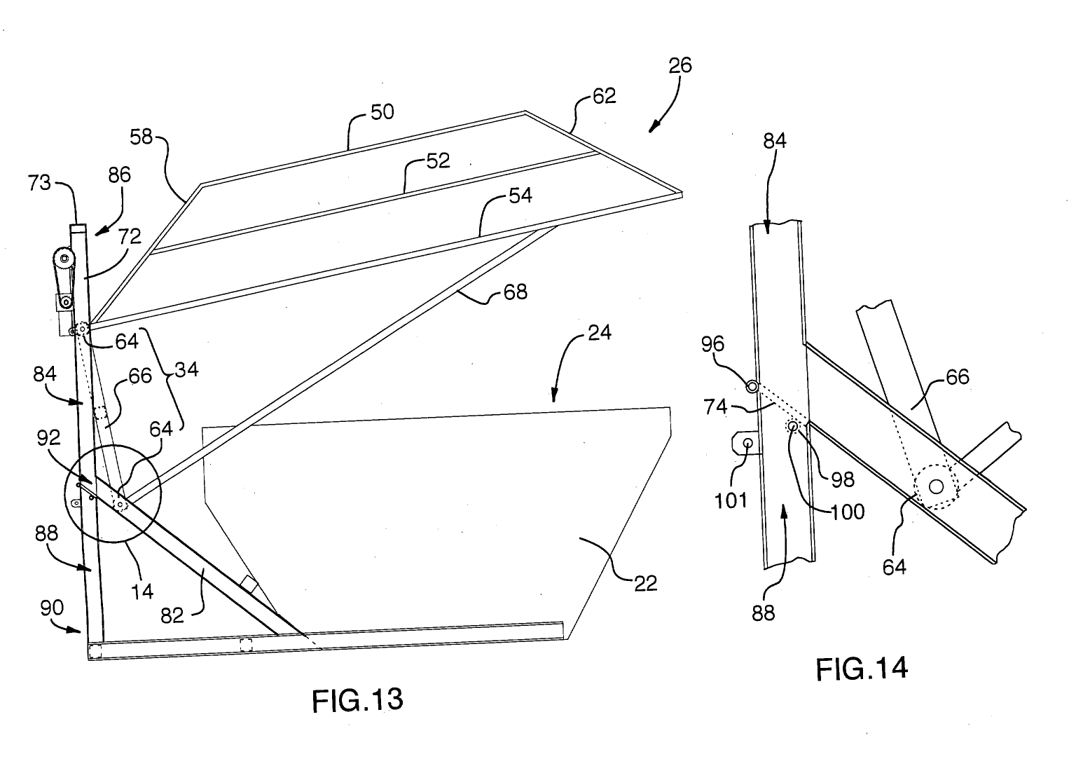

With the switch member 74 so repositioned, the motor 114 is actuated for reverse movement, thereby permitting the cables 110 to unspool, whereupon the cover assembly 26 moves under force of gravity to its open position shown in FIG. 15. Such movement of the cover assembly is illustrated in the sequence of FIGS. 9, 11, 13, 15.

It is worth noting at this time that the initial movement of the cover assembly 26 towards its sheltering position will tend to cause the cover assembly 26 to shed any snow loaded thereon. This is advantageous in that, inter alia, if the snow were to remain affixed to the cover assembly to form a composite snow/cover assembly structure, the centre of gravity of such structure might resist movement towards the open position.

With the cover assembly 26 disposed at its open position, the operator disengages the motor 114, remounts the vehicle and dumps his or her load into the bin 22. With dumping concluded, the operator will then dismount the vehicle; actuate the motor 114 to draw the cover assembly 26 back to its sheltering position; disengage the motor 114, thereby to lock the cover assembly 26 in position via the internal magnetic brake thereof; lockingly reposition the switch members 74 at their respective first positions; and actuate the motor 114 for reverse movement, thereby to allow the cables 110 to unspool, and permit the cover assembly 26 to revert under force of gravity to its sealed position shown in FIG. 5. It will be evident that during such motion of the cover assembly 26, there exists no physical barrier to ingress of the shuttle members 64 into the secondary passage 82, but it should be appreciated that friction created by the shuttle members 64, in combination with the centre of gravity of the cover assembly 26, create a force moment which biases the shuttle members 64 in a manner which avoids dislodgement from the primary passage 80, so as to avoid any likelihood for inadvertent ingress into the secondary passage 82, even in situations wherein the apparatus 20 is set on uneven terrain.

As shown in FIG. 5, when the bin is disposed at the operative position and the cover assembly is shown at the sealed position, the bin 22 fits within the cover assembly 26 in close-fitting relation.

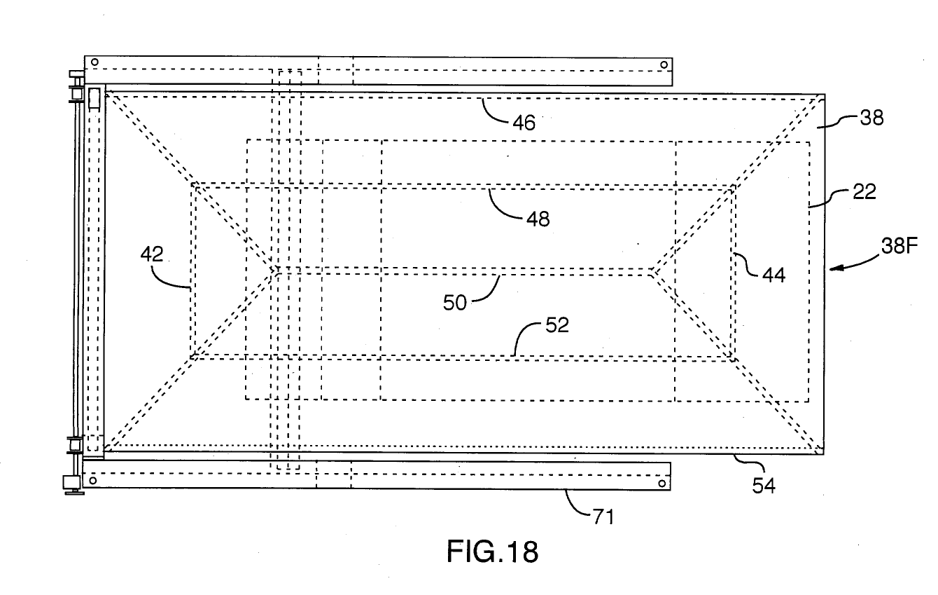

However, it should be understood that irregularities in terrain, and operator error, may result in the bin 22 being disposed at a position that is slightly displaced relative to the operative position. To account for such possibility, the forward edge 38F of the sheath 38 is preferably not supported with a rigid cross-piece, but rather, merely spans between the outermost longitudinal members 46, 54, as shown in FIG. 18, such that, in non-ideal terrain, the cover assembly 26 can travel to its sealed position without any possibility of binding; irregularities in position are accommodated by flexure of the vinyl sheath 38.

While but a single preferred embodiment of the present invention is herein shown and described, it should be understood that various modifications and alterations may be used in the design and manufacture of the apparatus of the present invention without departing from its spirit or scope.

For example, whereas the apparatus of the preferred embodiment provides for movement between the sheltering position, the sealed position and the open position, it is possible to produce a useful apparatus which provides for movement only between the sheltering position and the open configuration. In this regard it will be appreciated that, whereas in the preferred embodiment, a substantial air space exists between the bin and the cover assembly when in the sheltering position, this need not be the case. For example, a depending skirt (not shown) could be provided on the cover assembly, which could substantially block access to the bin 22 when the cover assembly was disposed at the sheltering position, while at the same time still providing significant access to the bin when the cover assembly is disposed at its open position. Such skirt would be provided with weights at the lower edge thereof, for better sealing.

As well, whereas the apparatus of the preferred embodiment provides for movement between the sheltering position, the sealed position and the open position by means of a bifurcated passage, it is possible to achieve similar functionality through other mechanisms, for example, through a reconfigurable (i.e. movable) lower track section (not shown).

Further, whereas internal magnetic brake components of the motor of the preferred embodiments serve to lock the cover assembly against movement under the force of gravity, which is advantageous, in that it provides for the cover to automatically lock in place in the event of a power failure, other mechanisms, such as a simple prop bar could be utilized with similar utility, in which case, it would not be strictly necessary to provide the motor with reverse functionality.

As well, whereas rollers are utilized in the preferred embodiment, other mechanical structures adapted for track-guided motion, such as pads of self-lubricating material, could conceivably be utilized with similar utility.

Of course, whereas square tubular steel is utilized in the construction of the bulk of the apparatus, other structural materials and shapes, such as round aluminum tubing could be utilized with equal utility, and similar modifications can be made in terms of the construction of the remaining components, as desired. As well, whereas a specific structure including lower struts is shown and described to provide for mounting of the cover portion to the carriage portions, other structures, such as upper guy wires (not shown) could equally be employed.

Further, whereas the preferred cover assembly is biased for movement by gravity, it is possible to construct a device which requires positive manipulation towards the sealed position and/or towards the open position. Counterweights could also be used, which could permit the cover assembly to be manually manipulated with relative ease between its sheltering, sealed and open positions.

Moreover, whereas the motor of the preferred embodiment is adapted to utilize the power supply of a fork lift or the like, the present apparatus could readily be provided with its own battery, possibly charged by solar energy, or coupled to an AC power grid. This would be of particular advantage in circumstances wherein actuation of the switch members 74 was automated, for example, by hydraulic cylinders actuable by radio remote control, which is also a possibility, and would make operation substantially more convenient, although at additional complexity and cost. Another option (not shown) would be to bias the switch members for movement by gravity towards their second positions, and to provide latch means for automatically locking said switch members upon movement thereto.

Similarly, whereas the actuation means of the preferred embodiment comprises an electric winch assembly, other conventional systems, such as a manual winch, or pneumatic or hydraulic cylinders could be utilized with similar utility.

As well, it should be understood that whereas the apparatus of the preferred embodiment illustrated is used with a specific form of bin, the apparatus may be conveniently modified for use with bins of various types and sizes by providing stop pins (not shown) in the bifurcated track, so as to arrest movement of the cover assembly at a suitable position. As well, it should similarly be recognized that whereas only a single bin is shown, the apparatus could readily be enlarged for use with two or even more bins.

Accordingly, it should be understood that the scope of the present invention is to be limited only by the accompanying claims, purposively construed.

I claim:

1. Apparatus for use with a bin having an open top, said apparatus comprising:
a cover assembly including a cover portion and one or more carriage portions, each carriage portion including a pair of spaced-apart shuttle members operatively mounted to said cover portion in spacially-fixed relation; and
guide means for permitting constrained movement of said shuttle members in a manner which provides for movement of said cover assembly between a substantially horizontal sheltering position, whereat said cover assembly substantially overlies said open top to impede infiltration of atmospheric precipitation into said bin when said bin is disposed at an operative position therebeneath, and an upwardly tilted open position, whereat said cover assembly is positioned to permit loading into said bin when said bin is operatively positioned.

2. Apparatus according to claim 1, wherein said guide means is further adapted to permit constrained movement of said shuttle members in a manner which provides for movement of said cover assembly between the sheltering position and a sealed position, relatively lower than the sheltering position, whereat said cover assembly is adapted to substantially seal said open top against the infiltration of atmospheric precipitation.

3. Apparatus according to claim 2, further comprising actuation means for selectively moving the cover assembly from its sealed position to its sheltering position, and for selectively moving the cover assembly from its open position to its sheltering position.

4. Apparatus according to claim 3, wherein the cover assembly is biased for movement by the force of gravity from its sheltering position to its sealed position.

5. Apparatus according to claim 4, further comprising switch means for selectively directing movement of the cover assembly from the sheltering position to the open position thereof, said cover assembly being biased by gravity for movement from said sheltering position to said open position when so selectively directed.

6. Apparatus according to claim 5, wherein the guide means comprises a support member for each carriage portion, said support member defining a bifurcated passage including an elongate primary passage and an elongate secondary passage, wherein the primary passage has an upper end portion including an upper end, a lower end portion including a lower end and an intermediate junction portion, and wherein the secondary passage extends downwardly from said junction portion, in skewed relation to the lower end portion of the primary passage, to a terminus, said bifurcated track having the shuttle members of said each carriage portion mounted therein for guided movement to permit movement of said carriage portion between:
a raised position adjacent the upper end of the primary passage which corresponds to the sheltering position of the cover assembly;
a lowered position, adjacent the lower end of the primary passage and which corresponds to the sealed position of the cover assembly; and
an offset position adjacent the terminus of the secondary passage and which corresponds to the open position of the cover assembly.

7. Apparatus according to claim 6, wherein the primary passage is substantially vertical.

8. Apparatus according to claim 6, wherein, at the sheltering position of the cover assembly, each pair of shuttle members is disposed, with respect to the support member for the carriage portion of which said pair forms part, adjacent the upper end and the junction portion of the primary passage, respectively.

9. Apparatus according to claim 6, wherein, at the sealed position of the cover assembly, each pair of shuttle members is disposed, with respect to the support member for the carriage portion of which said pair forms part, adjacent the lower end and the junction portion of the primary passage, respectively.

10. Apparatus according to claim 6, wherein, at the open position of the cover assembly, each pair of shuttle members is disposed, with respect to the support member for the carriage portion of which said pair forms part, adjacent the junction portion of the primary passage, and the terminus of the secondary passage, respectively.

11. Apparatus according to claim 6, wherein the switch means comprises, for said each carriage portion, a switch member mounted to the support member for said each carriage portion for movement between a first position, whereat said switch member permits ingress of said shuttle members into the lower end portion of the primary passage, and a second position, whereat said switch member directs shuttle members exiting the upper end portion of the primary passage into the secondary passage.

12. Apparatus according to claim 11, whereat said switch member, at its second position, directs shuttle members exiting the secondary passage into the upper end portion of the primary passage.

13. Apparatus according to claim 11, further comprising a manually-operable pin and socket locking assembly for each switch member, said pin and socket locking assembly being adapted to permit the switch member to be selectively locked at one of its first position and its second position.

14. Apparatus according to claim 11, wherein the switch member for said each carriage portion is hingedly mounted to the support member for said each carriage portion.

15. Apparatus according to claim 6, wherein the actuation means comprises a cable winch, the cable winch comprising
a laterally-extending shaft rotatably mounted to the support member for each carriage portion;
a pair of spools mounted in laterally-spaced relation on said shaft for rotation therewith;
a pair of cables, each cable being affixed at its ends, respectively, to a respective one of said pair of spools and to the cover assembly; and
motive means for selectively driving rotation of said shaft.

16. Apparatus according to claim 15, wherein the motive means comprises an electric motor drivingly coupled to said shaft.

17. Apparatus according to claim 16, wherein the electric motor is adapted to be electrically coupled to the power supply of a tow motor to receive power.

18. Apparatus according to claim 1, wherein each shuttle member comprises a roller operatively rotatably mounted to the cover portion.

19. Apparatus according to claim 1, wherein said one or more carriage portion comprises a pair of carriage portions.

20. Apparatus according to claim 1, wherein the cover portion comprises a rigid support skeleton and a mating flexible sheath portion.
